(19) United States
(12) Patent Application Publication
(10) Pub. No.: US 2002/0091581 A1
(43) Pub. Date: Jul. 11, 2002

(54) Method and system for processing access to a plurality of web sites

(76) Inventor: Hiroki Kudou, Kawasaki-shi (JP)

Correspondence Address: David L. McCombs, Haynes and Boone, LLP, Suite 3100, 901 Main street, Dallas, TX, 75202-3789, US

(21) Appl. No.: 09/812,172

(22) Filed: Mar. 19, 2001

(30) Foreign Application Priority Data
Jan. 5, 2001 (JP) 2001-000599

(51) Int. Cl. G06F 17/60

(52) U.S. Cl. 705/26

(57) ABSTRACT

The present invention provides a method for processing access to a plurality of web sites. The method comprises the steps of receiving information, from a plurality of sites, of a accessor who accesses any of the plurality of sites, performing accessor information matching to thereby identify each accessor, and associating the accessor information with one another, said accessor information obtained from each site, for highly-identical accessors according to results of the accessor information matching.

### BACKGROUND OF THE INVENTION

1. Field of the Invention

The present invention relates to a method and a system for processing access to a plurality of web sites, and more specifically, to a method and a system for efficiently integrating accessor information obtained from a plurality of Web sites.

2. Description of the Related Art

To date, a marketing method has been used for utilizing a Web site (hereafter, referred to as “site”), collecting information of a user who accesses the Web site (hereafter, referred to as “accessor”), and providing the accessor with a product or information which suits the accessor's preferences based on accessor information.

In order to collect the accessor information, one can devise a method for, for example, having an accessor enter information required for marketing or answer a questionnaire when the accessor purchases a product or applies for a free gift.

### SUMMARY OF THE INVENTION

It is well known that consumers are generally reluctant to enter their personal information on the Web. For this reason, there is a limit to how much consumer information can be collected. In addition, there is a concern that, if much information is required, consumers may lose their motivation to access the site.

On the other hand, an effective marketing cannot be achieved only by collecting information which accessors do not hesitate to enter.

An object of the present invention, created in consideration of the above circumstances, is to provide a method and a system for access processing for effectively performing preference analysis for an accessor based on accessor information which is received from each Web site.

More specifically, an object of the present invention is to provide a method and a system for access processing capable of effective marketing targeted to accessors including those who do not enter enough information on Web sites.

According to a first primary aspect of the present invention, created under the above circumstances, there is provided an access processing method, comprising the steps of: receiving information, from a plurality of sites, of an accessor; performing accessor information matching to thereby identify each accessor; and associating the accessor information with one another, which is obtained from each site, for highly-identical accessors according to results of the aforesaid accessor information matching.

According to such a structure, it is possible to integrate accessor information, which is received from various sites, based on the accessor's identity. Thus, it is possible to accumulate specific accessor 's information, which is difficult to collect from only one site, to thereby effectively analyze the accessor's preferences. Also, since the accessor's identity can be determined by matching the accessor's attribute without specifying the accessor, the accessor's privacy is protected.

According to one embodiment of the present invention, this access processing method comprises the step of categorizing preferences for highly-identical accessors based on their accessor information, the aforesaid accessor information obtained from each site. Here, the aforesaid access processing method preferably further comprises the steps of: determining a product to be offered to an accessor based on his/her categorized preferences; and sending information of the product to the accessor. In this case, it is desirable that the aforesaid step of determining a product to be offered to an accessor based on his/her categorized preferences determines the product by matching the accessor's categorized preferences with existing product information.

According to such a structure, since it is possible to obtain diversified information on the accessor by integrating information for highly-identical accessors, an accurate preference analysis can be performed. Moreover, since it is possible to determine a product suited for the accessor, an effective marketing can be achieved by, for example, presenting the product to the accessor instantly.

According to another one embodiment, the aforesaid access processing method further comprises the step of receiving information of an accessor from a site, which is accessed by the accessor, and providing the information to another specific site, which is accessed by another accessor, who is highly identical to the accessor.

According to such a structure, the aforesaid another site can share the accessor's information.

According to still another one embodiment, the aforesaid access processing method preferably comprises the steps of: categorizing preferences for highly-identical accessors based on their accessor information, which is obtained from each site; and sending the highly-identical accessors' categorized preferences to the aforesaid each site.

According to such a structure, each site accessed by the accessor can obtain the accessor's preference information, which cannot be determined only by an accessed site itself.

According to yet another one embodiment, information received from each site includes incident information in business transactions between the aforesaid each site and an accessor; and the aforesaid access processing method comprises the step of sharing the incident information, which is regarding an accessor at a specific site, for reference with a site where another accessor, who is highly identical to the aforesaid accessor, attempts to perform a new business transaction.

According to such a structure, it is possible to determine whether the accessor has an incident history in business transactions based on the accessor's identity determination (accessor identification).

According to a second primary aspect of the present invention, there is provided an access processing system comprising: means for receiving and storing information from a plurality of sites regarding an accessor, who accesses any of the plurality of sites; an identity determination means for performing accessor information matching to thereby identify each accessor, who accesses any of the plurality of sites; and means for associating the accessor information with one another, which is obtained from each site, for highly-identical accessors according to the results of the aforesaid accessor information matching.

According to such a structure, it is possible to obtain a system capable of implementing the aforesaid access processing method, which is the first primary aspect of the present invention.

Other characteristics and marked effects of the present invention will become apparent to those skilled in the art upon referring to descriptions of the following specification when taken in conjunction with the accompanying drawings.

### BRIEF DESCRIPTION OF THE DRAWINGS

FIG. 1 is a schematic structural view showing one embodiment of the present invention;

FIG. 2 is a schematic structural view describing a system structure of a central server;

FIG. 3 is a flowchart showing processing procedures of the one embodiment;

FIG. 4 is a drawing showing an example of accessor information;

FIG. 5 is a conceptual diagram describing preference determination for an accessor, which is performed based on the accessor information in FIG. 4; and

FIG. 6 is a flowchart showing procedures for determining an incident history of the accessor.

### DETAILED DESCRIPTION OF THE PREFERRED EMBODIMENT

One embodiment of the present invention will be described below based on the accompanying drawings.

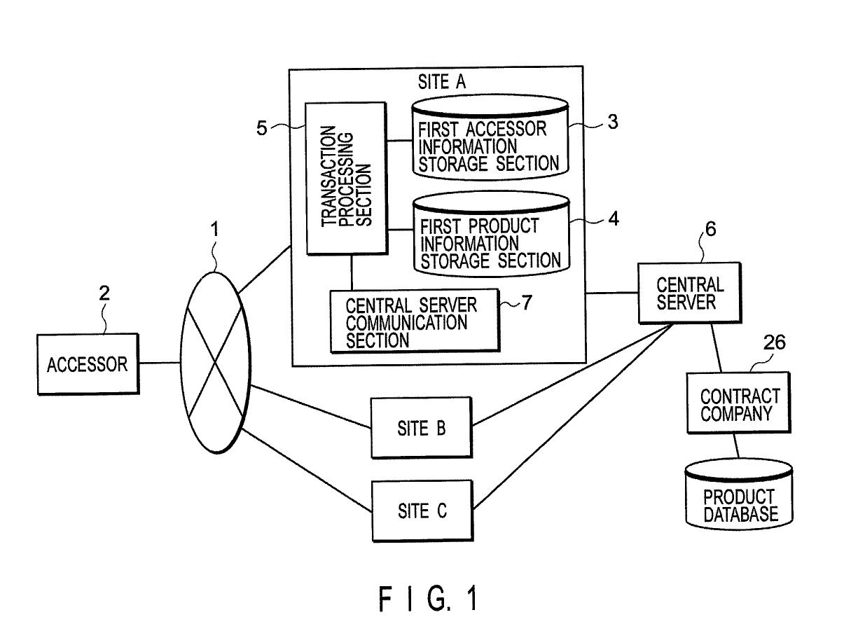

FIG. 1 is a schematic structural view showing an overall structure of this embodiment.

A-C, shown in FIG. 1, are public Web sites on an Internet network 1. Each of these sites A-C is structured to provide a certain service to its accessor (accessor 2), who accesses the site through the Internet network 1. Each of the sites A-C is independent and, although they may be mutually linked, does not directly interact with each other as a general rule.

Each of these sites A-C, shown in a site A of FIG. 1, have a first accessor information storage section 3, a first product information storage section 4 and a transaction processing section 5, respectively. This transaction processing section 5 is structured to present a product, which is registered in the first product information storage section 4, to the accessor 2 on the sites A-C as well as to manage information, which is entered by the accessor 2 using the first accessor information storage section 3.

Also, each of the sites A-C is connectable to a central server 6, which is a key section of the present invention, through the Internet network 1 or a public circuit network. Each of the sites A-C has a central server communication section 7 for sending part of the accessor 2's information, which does not invade the accessor 2's privacy, to the central server 6 from the aforesaid first accessor information storage section 3. In this embodiment, for example, the central server communication section 7 sends information such as accessor 2's age, preferences and the like, which itself will not reveal the accessor 2's identity, to the central server 6.

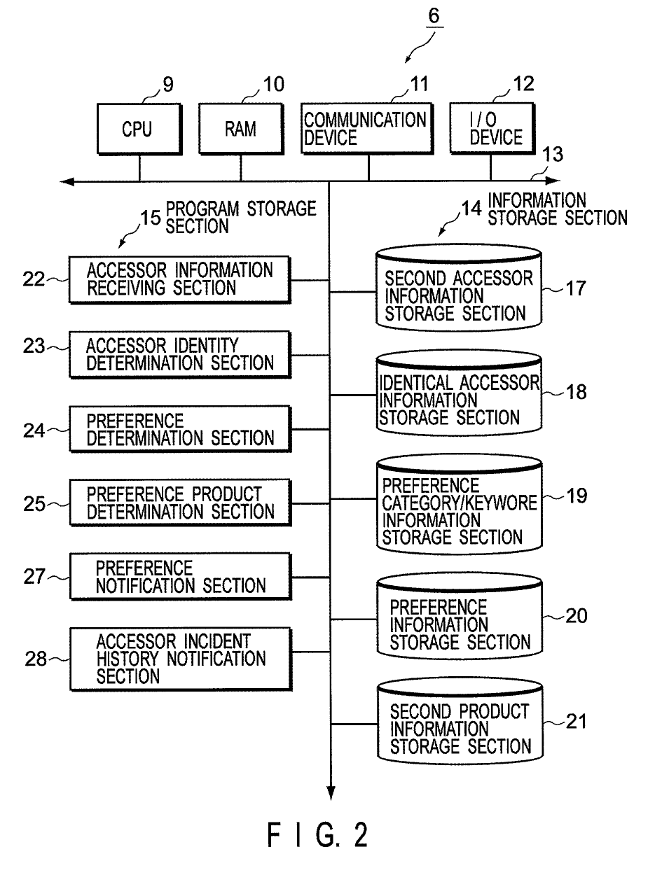

FIG. 2 is a system structure diagram showing the aforesaid central server 6. This central server 6 is defined by an information storage section 14 and a program storage section 15, both connected with a bus 13, which is connected with a CPU 9, a RAM 10, a communication device 11, an I/O device 12 and the like.

The information storage section 14 has a second accessor information storage section 17, an identical accessor information storage section 18, a preference category/keyword information storage section 19, a preference information storage section 20 and a second product information storage section 21 therein.

First, the second accessor information storage section 17 stores the accessor information received from each of the aforesaid sites A-C. Aspects of the accessor information collected at the sites A-C differ depending on the site, even if an identical accessor enters the accessor information, since each of these sites has different characteristics.

The aforesaid identical accessor information storage section 18 stores index information for mutually associating accessor information, which is entered by highly-identical accessors and obtained from an entire accessor information received from sites A-C.

The aforesaid preference category/keyword information storage section 19 stores preference categories or keywords, which is a basis for determining the accessor 2's preferences based on the accessor information. These preference categories or keywords are associated with each piece of information (accessor information), which can be selected or entered by the accessor 2 at each site. The accessor 2's preferences can be categorized into specific preference categories or keywords based on the aforesaid accessor information.

The aforesaid preference information storage section 20 stores accessor 2's preference information, which is categorized as above. Concomitantly, the aforesaid second product information storage section 21 stores product information (product name, price, sales points and the like) which is matched with the aforesaid preference information.

The aforesaid program storage section 15 has an accessor information receiving section 22 for receiving the accessor information from each of the sites A-C and storing the accessor information in the aforesaid second accessor information storage section 17, an accessor identity determination section 23 for matching accessor information, which is received from each of the sites A-C, to thereby determine the accessor 2's identity, mutually associating the accessor information for highly-identical accessors, and storing required information in the aforesaid identical accessor information storage section 18, a preference determination section 24 for determining the accessor 2's preferences based on information which is stored in the aforesaid identical accessor information storage section 18, and storing determined accessor 2's preferences in the aforesaid preference category/keyword information storage section 19, a preference product determination section 25 for determining a product which is suited for preferences of the accessor 2 (customer) based on this preference information from products stored in the aforesaid second product information storage section 21, a preference notification section 27 for sending the aforesaid preference information or preference product information to each of the sites A-C or a contract company, shown as 26 in FIG. 1., and an accessor incident history notification section 28 for notifying the accessor 2's incident history to each site.

Incidentally, each of these components of the present invention consists of computer software programs and a storage medium for storing those programs, and functions of the present invention are actually performed by the aforesaid CPU 9, which calls the programs and execute them on the RAM 10.

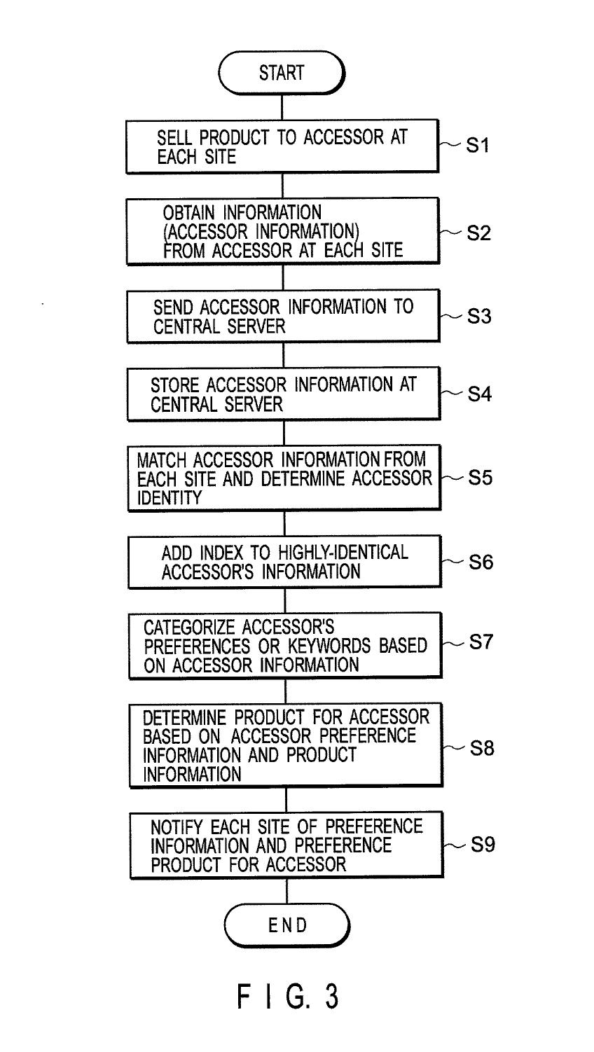

Functions of the these components will be described below in accordance with their actual operations. FIG. 3 is a flowchart showing the operations.

S1-S9 in FIG. 3 are codes for referencing each process and they correspond to codes used in the following descriptions, respectively.

First, if the accessor 2 accesses the site A and purchases a product, for example, the aforesaid transaction processing section 5 presents to the accessor 2 the product information, which is stored in the aforesaid first product information storage section 4, and conducts the sales (step S1). During this sales operation, the site A prompts the accessor 2 to submit a user registration (for registering bibliographic items) and to answer a questionnaire, obtains the accessor 2's information and registers this information in the aforesaid first accessor information storage section 3 (step S2). The transaction processing section 5 also registers information of the product sold to the accessor 2 at this site A in the aforesaid first accessor information storage section 3. As a result, the accessor 2's information will be accumulated together with a customer ID at the site A in the aforesaid first accessor information storage section 3.

Next, the site A sends part of the accessor 2's information, which does not invade the accessor 2's privacy, from the aforesaid first accessor information storage section 3 to the central server 6 (step S3). Preferably, this information includes customer ID's from each of the sites A-C. Selection and transmission of this information is performed by the aforesaid central server communication section 7 and the accessor 2's information, which is obtained from a plurality of sites A-C, will be centrally stored in the second accessor information storage section 17 of the aforesaid central server 6 (step S4).

Next, the aforesaid accessor identity determination section 23 of the central server 6 matches information in the aforesaid second accessor information storage section 17 to thereby determine an identity of the accessor 2, who accesses the plurality of sites A-C (step S5). If a plurality of accessors 2 are highly identical, each of their information is added with an index and mutually associated as information of one identical accessor 2. This index information will be stored in the aforesaid identical accessor information storage section 18 (step S6). Thus, various information can be obtained and accumulated for analyzing a specific accessor 2 from various aspects.

Next, the preference determination section 24 of the central server 6 categorizes the accessor 2's preferences or keywords based on the aforesaid accessor information (step S7). Also, information of highly-identical accessors 2 is integrated based on the aforesaid index information in order to determine the accessor 2's preferences.

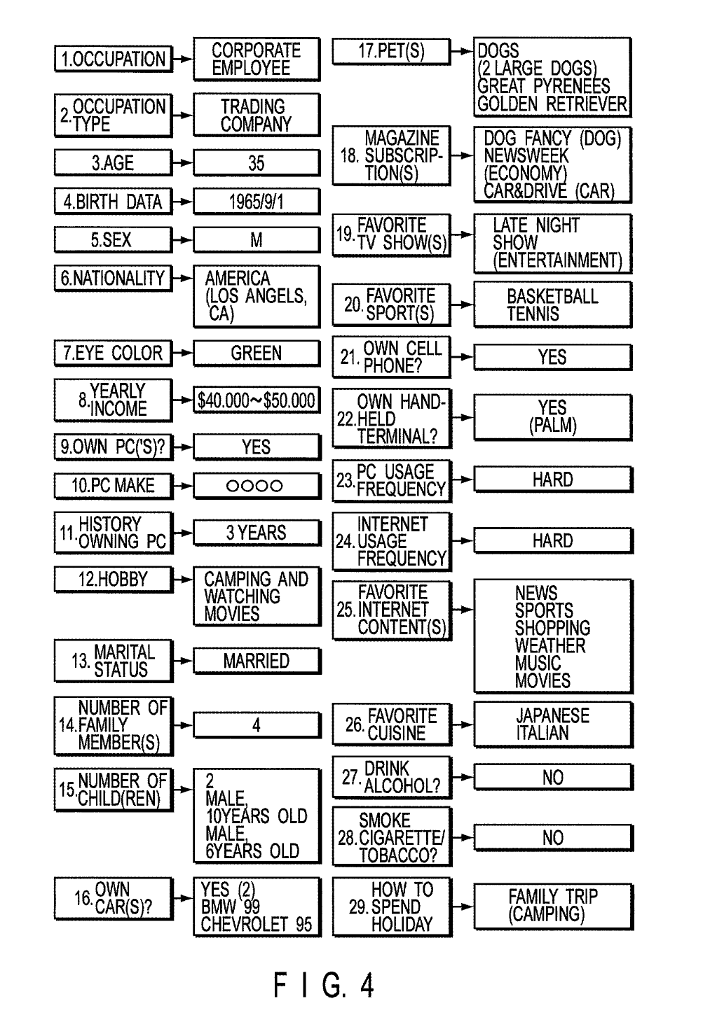

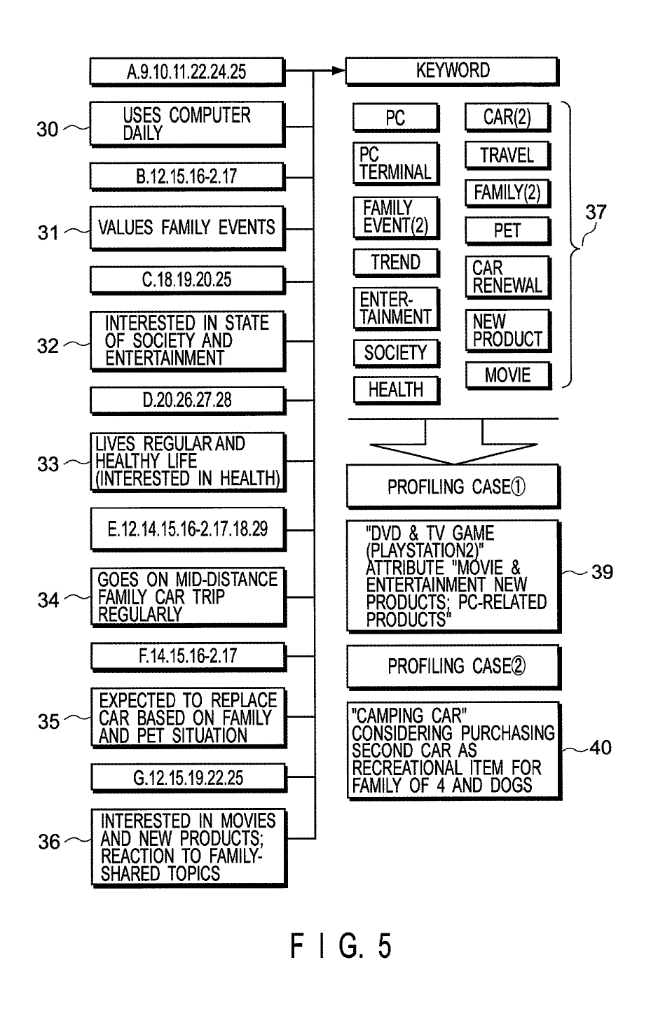

FIG. 4 and FIG. 5 are schematic diagrams for understanding procedures of preference determination. FIG. 4 shows 29 items of information as an example of the accessor information stored in the aforesaid second accessor information storage section 17. In this example, accessor 2's preference categories and keywords are determined as shown in FIG. 5 based on each item.

More specifically, the aforesaid preference determination section 24 assigns appropriate preference categories and keywords to this accessor 2 based on the 29 items, shown in FIG. 4, and the accessor information associated with the preference categories and keywords in the aforesaid preference category/keyword information storage section 19 (step S7). In FIG. 5, reference numerals 30-36 and 37 indicate preference categories and keywords assigned to this accessor 2, respectively. The preference information determined as above is stored in the aforesaid preference information storage section 20.

Next, the preference product determination section 25 matches the accessor 2's preference information and the product information, stored in the aforesaid second product information storage section 21, and determines a product which the accessor 2 prefers (step S8). More specifically, one or more products can be extracted since the aforesaid second product information storage section 21 stores therein the aforesaid product information in association with the aforesaid preference categories and keywords. In this example, as shown in FIG. 5, “DVD, TV GAME” (shown in FIG. 5 as 39) and “CAMPING CAR” (shown in FIG. 5 as 40) are extracted. Preference product information extracted as above will also be stored in the aforesaid preference information storage section 20.

Next, the aforesaid preference notification section 27 notifies the sites A-C or the contract company 26 of the preference information and the preference product information in association with the accessor 2 with a predetermined timing. Thus, each of the sites A-C or the contract company 26 can perform appropriate and highly effective marketing to the accessor 2. Here, the contract company 26 can pre-register its products, which are registered in its own product database, in the second product information storage section 21 of the aforesaid central server 6, and sell its products through each of the sites A-C. Also, the contract company 26 can extend a product offer to the accessor 2 through direct mail and the like if the accessor 2's authorization or request is obtained.

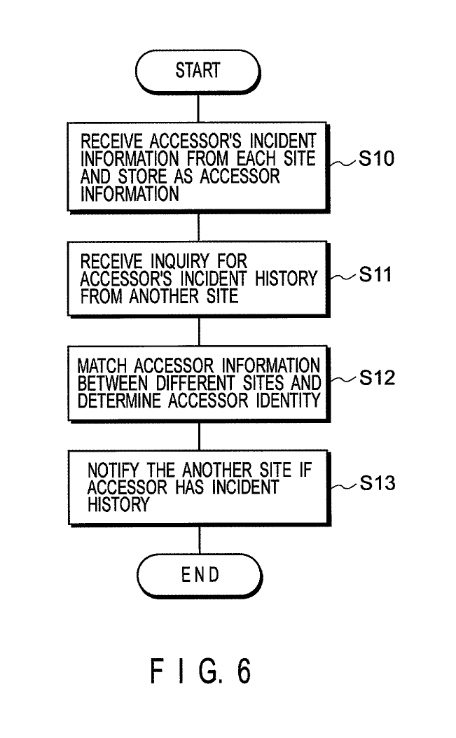

FIG. 6 is a flowchart showing processing procedures (S10˜S13) when the accessor 2's incident information in business transactions is shared as the accessor information.

First, one of the sites A-C sends incident information as well as the accessor information, described above, for the accessor 2 to the aforesaid central server 6. The central server 6 registers this incident information also as part of the accessor information in the aforesaid second accessor information storage section 17 (step S10).

Next, if the accessor 2's incident history is requested from another different site (step S11), this central server 6 determines the accessor 2's identity using the accessor information from this another site (step S12). Identity determination (for the accessor 2) in this case should be performed more strictly than the identity determination during the aforesaid preference determination, shown as the step S5 in FIG. 3. This is due to a significant effect of the incident history on the accessor 2's credit. If there is any incident history found in the accessor information for the accessor, who is determined identical with the accessor 2, the aforesaid accessor incident history notification section 28 notifies the aforesaid another different site (step S13).

Thus, a probability of incident occurrence can be evaluated for the accessor 2 at a site where there has been no incident history with the accessor 2.

According to a structure described above, it is possible to determine an identity among accessors using information collected at a plurality of sites and integrate the accessor information. In this case, the accessor 2's identity can be determined by matching accessor information even if information obtained from each site does not include information which enables direct identification of the accessor 2 (e.g., name, address and the like).

Also, since the accessor information can be integrated for highly-identical accessors, diversified accessor information can obtained compared to obtaining accessor information from a single site. Thus, the accessor 2's preference can be accurately determined.

Moreover, effective marketing can be realized by determining a product (products) to be offered to the accessor 2 based on this effective accessor identification.

Furthermore, since the accessor 2's incident history can be shared according to this embodiment, sites with no prior incident history with the accessor 2 can receive incident history information, if any, for an accessor who is determined to be identical with the accessor 2 as a result of the accessor identity determination.

Incidentally, the present invention is not limited to the aforesaid one embodiment and can be modified variously, without departing from the scope and spirit of the present invention.

For example, the sites A-C are not limited to selling products. For example, there is an objective to collect the accessor 2's information from the site A and the site B as efficiently as possible. To effectively achieve this objective in this embodiment, the site A can be a well-known product retail site with a history of selling products for a period of time in the past. This site A can easily collect the accessor 2's information when selling products. The site B can be an antenna site which receives applications for free gifts and product monitoring to collect the accessor 2's information.

In the above case, the site C can be a site to attract the accessor 2 who entered their information at the site A or the site B, and sell products, services and the like to new customers. Sales items at the site C are preferably nonessential items such as cosmetic, jewelry and travel products and the like.

Further, the aforesaid one embodiment determines a specific product for the accessor 2 in addition to the accessor 2's preferences. However, the one embodiment can simply provide the preference information. Also, it can integrate information for the highly-identical accessors and provide integrated information directly to each site.

Moreover, the one embodiment can execute processes shown in FIG. 3 and provide the accessor 2 with services suited for the accessor 2's preferences at each site upon accessor 2's access.

According to the structure described above, there can be provided a method and a system for access processing capable of effective analysis on the accessor's preferences and the like based on the accessor information received from each Web site.

In addition, there can be provided a method and a system for access processing capable of effective marketing even when the accessor does not enter enough information at each Web site.

What is claimed is:

1. A method for processing access to a plurality of web sites, comprising the steps of:
receiving information, from a plurality of sites, of a accessor who accesses any of the plurality of sites;
performing accessor information matching to thereby identify each accessor; and
associating the accessor information with one another, said accessor information obtained from each site, for highly-identical accessors according to results of said accessor information matching.

2. A method as set forth in claim 1, comprising the step of categorizing preferences for highly-identical accessors based on their accessor information, said accessor information obtained from each site.

3. A method as set forth in claim 2, further comprising the steps of:
determining a product to be offered to an accessor based on his/her categorized preferences; and
sending information of the product to the accessor.

4. A method as set forth in claim 3, wherein said step of determining a product to be offered to an accessor based on his/her categorized preferences determines the product by matching the accessor's categorized preferences with existing product information.

5. A method as set forth in claim 1, further comprising the step of receiving information of an accessor from a site, the site accessed by the accessor, and providing the information to another specific site, said another specific site accessed by another accessor, said another accessor highly identical to the accessor.

6. A method as set forth in claim 1, further comprising the steps of:
categorizing preferences for highly-identical accessors based on their accessor information, said accessor information obtained from each site; and
sending the highly-identical accessors' categorized preferences to said each site.

7. A method as set forth in claim 1,
wherein information received from each site includes incident information in business transactions between said each site and an accessor;
comprising the step of sharing incident information for reference, said incident information of an accessor at a specific site, with a site where another accessor, said another accessor highly identical to said accessor, attempts to perform a new business transaction.

8. A system for processing access to a plurality of web sites, comprising:
means for receiving and storing information, from a plurality of sites, of an accessor, said accessor accessing any of the plurality of sites;
an identity determination means for performing accessor information matching to thereby identify each accessor, said accessor accessing any of said plurality of sites; and
means for associating the accessor information with one another, said accessor information obtained from each site, for highly-identical accessors according to results of said accessor information matching.

9. A system as set forth in claim 8, comprising means for categorizing preferences for highly-identical accessors based on their accessor information, said accessor information obtained from each site.

10. A system as set forth in claim 9, further comprising:
a product determination means for determining a product to be offered to an accessor based on his/her categorized preferences; and
means for sending information of the product to the accessor.

11. A system as set forth in claim 10, wherein said product determination means determines the product by matching the accessor's categorized preferences with existing product information.

12. A system as set forth in claim 8, further comprising means for receiving information of an accessor from a site, the site accessed by the accessor, and providing the information to another specific site, said another specific site accessed by another accessor, said another accessor highly identical to the accessor.

13. A system as set forth in claim 8, further comprising:
means for categorizing preferences for highly-identical accessors based on their accessor information, said accessor information obtained from each site; and
means for sending the highly-identical accessors, categorized preferences to said each site.

14. A system as set forth in claim 8,
wherein information received from each site includes incident information in business transactions between said each site and an accessor,
comprising means for sharing incident information for reference, said incident information of an accessor at a specific site, with a site where another accessor, said another accessor highly identical to said accessor, attempts to perform a new business transaction.
